(19) United States
(12) Patent Application Publication
(10) Pub. No.: US 2020/0042247 A1
(43) Pub. Date: Feb. 6, 2020

(54) MEMORY DEVICE AND MEMORY SYSTEM INCLUDING THE SAME

(71) Applicant: Samsung Electronics Co., Ltd., Suwon-si (KR)

(72) Inventors: Sueng-chul RYU, Hwaseong-si (KR); Young-jin CHO, Seoul (KR)

(21) Appl. No.: 16/445,340

(22) Filed: Jun. 19, 2019

(30) Foreign Application Priority Data
Aug. 6, 2018 (KR) 10-2018-0091442

(51) Int. Cl. G06F 3/06

(52) U.S. Cl. CPC G06F 3/0659; G06F 3/0673; G06F 3/0604

(57) ABSTRACT

A memory device includes at least one memory configured to communicate with a memory controller; and a memory accelerator provided separate from the at least one memory and configured to communicate with the at least one memory, wherein the memory accelerator includes a compatible logic configured to perform a data processing/restoration operation adaptively corresponding to a data processing/restoration type of the memory controller.

### CROSS-REFERENCE TO RELATED APPLICATION

This application claims the benefit of Korean Patent Application No. 10-2018-0091442, filed on Aug. 6, 2018, in the Korean Intellectual Property Office, the disclosure of which is incorporated herein in its entirety by reference.

### BACKGROUND

The inventive concept relates to a memory device and a memory system for ensuring compatibility between a memory controller (or a host) and the memory device in a data processing/restoration operation.

A memory accelerator in a memory system may perform a memory operation to distribute the load of a memory controller. The memory controller and the memory accelerator may share the same memory in a memory system. Since the memory operation is performed by sharing the same memory, ensuring compatibility between the memory controller and the memory accelerator is emerging as an important issue.

### SUMMARY

The inventive concept provides a memory device and a memory system which enable a memory accelerator that performs a memory operation for distributing the load of a memory controller (or a host) to reliably and efficiently perform a data processing/restoration operation corresponding to a supportable data processing/restoration type of the memory controller.

According to an aspect of the inventive concept, there is provided a memory device including at least one memory configured to communicate with a memory controller; and a memory accelerator provided separate from the at least one memory and configured to communicate with the at least one memory, wherein the memory accelerator includes a compatible logic configured to perform a data processing/restoration operation adaptively corresponding to a data processing/restoration type of the memory controller.

According to another aspect of the inventive concept, there is provided a memory system including a plurality of memories; a memory controller configured to perform a first memory operation on the plurality of memories; and a memory accelerator provided separate from the plurality of memories and configured to perform a second memory operation on the plurality of memories to access the plurality of memories, wherein, when the memory accelerator performs the second memory operation, the memory accelerator configures a compatible logic set to have a data processing/restoration type corresponding to a data processing/restoration type that is a basis for the first memory operation of the memory controller.

According to another aspect of the inventive concept, there is provided a memory system including: a plurality of memories; a memory controller configured to access the plurality of memories; and a memory accelerator provided separate from the plurality of memories and configured to access the plurality of memories. The memory accelerator comprises a compatible logic configured to either perform a data processing/restoration operation adaptively corresponding to a data processing/restoration type of the memory controller or do not perform the data processing/restoration operation based on whether the memory controller supports the data processing/restoration type.

### BRIEF DESCRIPTION OF THE DRAWINGS

Embodiments of the inventive concept will be more clearly understood from the following detailed description taken in conjunction with the accompanying drawings in which:

FIG. 1 is a diagram schematically illustrating a computing system according to an embodiment of the inventive concept;

FIG. 2 is a block diagram illustrating a memory system according to an embodiment of the inventive concept;

FIG. 3 is a block diagram specifically illustrating a data processing/restoration logic of FIG. 2 according to example embodiments;

FIG. 4 is a flowchart for explaining operations of a memory accelerator of FIG. 2 for compatibility with a memory controller according to example embodiments;

FIG. 5 is a block diagram illustrating a memory system according to an embodiment of the inventive concept;

FIG. 6 is a block diagram illustrating a memory system according to an embodiment of the inventive concept;

FIG. 7 is a flowchart for explaining operations of a memory accelerator of FIG. 6 for compatibility with a memory controller according to example embodiments;

FIG. 8 is a block diagram of a memory system for explaining a structure of a memory controller connected to heterogeneous memory devices according to an embodiment of the inventive concept;

FIGS. 9A and 9B are block diagrams of a memory system for explaining an operation of enabling/disabling a compatible logic according to example embodiments;

FIG. 10 is a flowchart for explaining operations of a memory accelerator of FIG. 9A for compatibility with a memory controller according to example embodiments;

FIG. 11 is a block diagram illustrating a memory system according to example embodiments;

FIG. 12 is a block diagram illustrating a memory device of a stacked structure according to an embodiment of the inventive concept;

FIG. 13 is a diagram illustrating a semiconductor memory module including a plurality of semiconductor memory packages according to an embodiment of the inventive concept; and

FIG. 14 is a block diagram showing an example in which a memory device is applied to a mobile system according to an embodiment of the inventive concept.

### DETAILED DESCRIPTION

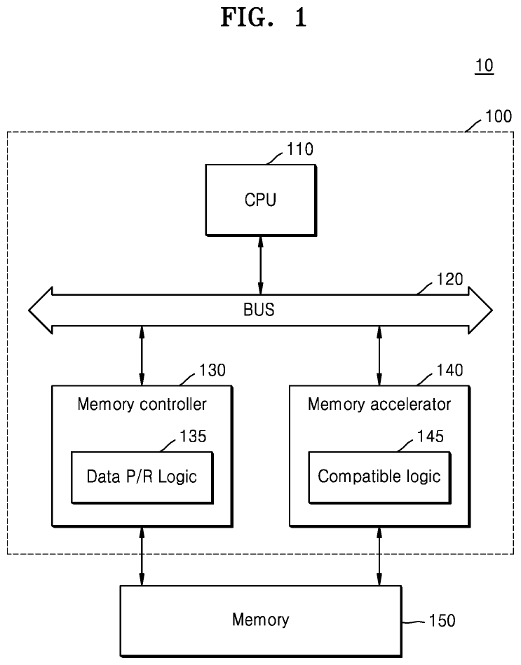

FIG. 1 is a diagram schematically illustrating a computing system 10 according to an embodiment of the inventive concept.

Referring to FIG. 1, the computing system 10 may include an integrated circuit 100 and at least one memory 150 connected to the integrated circuit 100. Although one memory 150 is shown in FIG. 1 for convenience of explanation, the number of memories of the inventive concept is not limited thereto. The integrated circuit 100 may include a central processing unit (CPU) 110, a bus 120, a memory controller 130, and a memory accelerator 140. In an embodiment, the integrated circuit 100 may be implemented as a system-on-chip (SoC), or the memory accelerator 140 may be implemented as an off-chip separate from the integrated circuit 100. In example embodiments, the memory accelerator 140 may be provided as a buffer chip or a buffer die separate from the memory 150. Alternatively, the memory accelerator 140 may be implemented as an application specific integrated circuit (ASIC) separate from the memory 150 and customized for a specific application. Alternatively, the memory accelerator 140 and the memory 150 may be implemented as a single memory device. For example, the single memory device including the memory accelerator 140 and the memory 150 may be implemented as a package. As an example, each of the memory accelerator 140 and the memory 150 may be implemented as a die or a chip which is manufactured from a semiconductor wafer.

In example embodiments, the memory 150 may be implemented as a die, a chip, or a package.

The CPU 110 may be implemented to control an operation of the integrated circuit 100 by driving an operating system. The CPU 110 may be implemented to perform an arithmetic logic operation or perform data processing according to instructions. The CPU 110 may include a program counter, an arithmetic logic unit (ALU), a register, and the like, although not shown.

The memory controller 130 may perform memory operations such as programming or reading data to or from the memory 150 in response to a request from the CPU 110. The memory controller 130 may include a data processing/restoration logic 135. The data processing/restoration logic 135 may perform processing or restoration on the data when the memory controller 130 performs the memory operation on the memory 150. That is, the data processing/restoration logic 135 may process predetermined data, and the processed data may be stored in the memory 150. The data processing/restoration logic 135 may read the processed data from the memory 150 and restore the read data. Although the data processing/restoration logic 135 corresponding to one type is included in the memory controller 130 in FIG. 1, the memory controller 130 may support various data processing/restoration types. The data processing/restoration logic 135 will be described in detail with reference to FIG. 3. The memory controller 130 and the CPU 110 may be collectively referred to as a host.

The memory accelerator 140 may distribute the load of the memory controller 130 by directly accessing the memory 150 to perform a simple repetitive memory operation (or a computationally intensive operation) instead of the memory controller 130. The “directly accessing” may mean that data are transferred between the memory accelerator 140 and the memory 150 without an intervening component (e.g., a buffer, a die, a chip, etc.). Distributing the load of the memory controller 130 may ultimately reduce the load of the CPU 110 that controls the memory controller 130, and thus, the CPU 110 may be more efficiently used to perform more complex operations or data processing. The memory accelerator 140 may be referred to as a memory proximity processor that is directly connected to the memory 150 to perform a memory operation on the memory 150. The memory accelerator 140 may be implemented as a function in memory FIM including logic for performing the memory operation.

The CPU 110, the memory controller 130, and the memory accelerator 140 may be connected to each other via the bus 120. The CPU 110 may request memory operations to the memory controller 130 and the memory accelerator 140 via the bus 120. The memory controller 130 and the memory accelerator 140 may also send and receive information (or signals) necessary for the setting of a compatible logic 145 via the bus 120.

In an embodiment of the inventive concept, the memory accelerator 140 may include the compatible logic 145. The compatible logic 145 may be compatible to perform a data processing/restoration operation corresponding to the data processing/restoration type of the data processing/restoration logic 135 included in the memory controller 130. For example, since the memory accelerator 140 and the memory controller 130 directly access the memory 150 to perform the memory operation, no error may occur in the memory operation when a data processing/restoration type supported by the memory accelerator 140 and a data processing/restoration type supported by the memory controller 130 need to be consistent. The memory controller 130 may support various data processing/restoration types according to a product type, an operation status, etc., and thus, to maintain compatibility with the memory controller 130, the compatible logic 145 of the memory accelerator 140 may adaptively support the same data processing/restoration type as the data processing/restoration type supported by the memory controller 130. In an embodiment, the compatible logic 145 may be implemented in hardware logic or in software logic. When the compatible logic 145 is implemented in software logic, the memory accelerator 140 may perform the data processing/restoration operation by executing or programming the compatible logic 145.

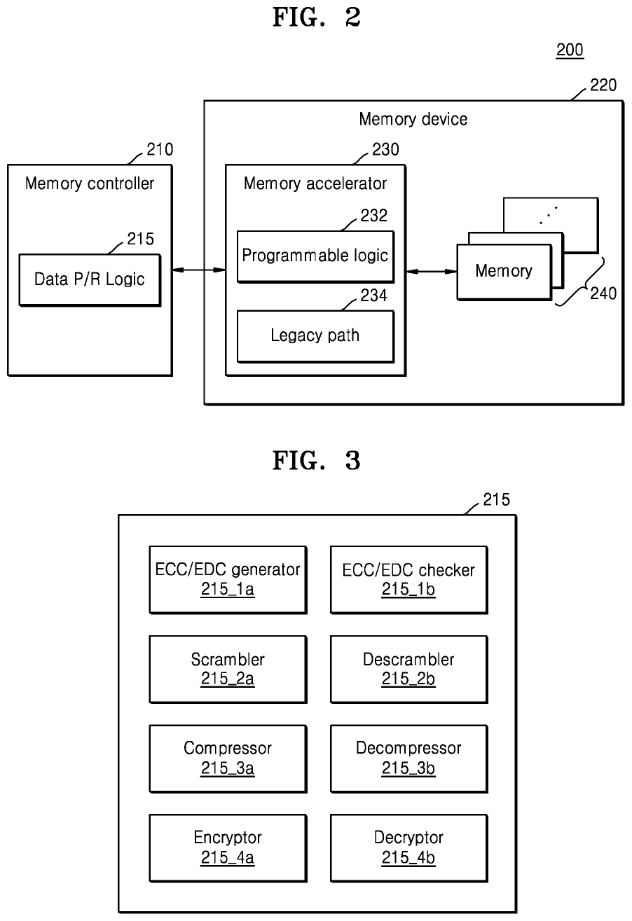

In an embodiment, the memory accelerator 140 may receive information related to a data processing/restoration type from the memory controller 130 and may set the compatible logic 145 based on the information related to the data processing/restoration type. Setting the compatible logic 145 may include programming the same data processing/restoration logic as the data processing/restoration logic 135 of the memory controller 130 to the compatible logic 145 or selecting the same data processing/restoration logic as the data processing/restoration logic 135 from a plurality of data processing/restoration logics included in the compatible logic 145, or enabling/disabling the compatible logic 145. This will be described in specific embodiments with reference to FIGS. 2 to 8, 9A, 9B, and 10 to 14.

The memory 150 may be configured to store data necessary for operations performed by the CPU 110. In example embodiments, the memory 150 may be implemented as dynamic random access memory (DRAM), synchronous dynamic random access memory (SDRAM), double data rate synchronous DRAM (DDR SDRAM), low power double data rate (LPDDR) SDRAM, Rambus DRAM (RDRAM), Dual In-line Memory Module (DIMM), Nonvolatile DIMM (NVDIMM), Phase Change Random Access Memory (PRAM), mobile DRAM, static random access memory (SRAM), NAND flash memory, NOR flash memory, electrically erasable programmable read-only memory (EEPROM), resistance random access memory (RRAM), Nano Floating Gate Memory (NFGM), Polymer Random Access Memory (PoRAM), Magnetic Random Access Memory (MRAM), Ferroelectric Random Access Memory (FRAM), etc.

The compatible logic 145 according to an embodiment of the inventive concept may be compatible to conform to the data processing/restoration type supported by the memory controller 130, and thus the memory accelerator 140 may smoothly perform the memory operation for reducing the load of the memory controller 130.

FIG. 2 is a block diagram illustrating a memory system 200 according to an embodiment of the inventive concept. Hereinafter, an embodiment in which the compatible logic 145 of FIG. 1 is implemented as a programmable logic 232 is described.

Referring to FIG. 2, the memory system 200 may include a memory controller 210 and a memory device 220. The memory controller 210 may include a data processing/restoration logic 215.

The memory device 220 may include a memory accelerator 230 and a plurality of memories 240. The memory accelerator 230 may include the programmable logic 232 and a legacy path 234. The memory accelerator 230 may be referred to as a programmable logic device PLD and may be implemented as an off-chip separate from the memories 240. The programmable logic 232 will be described in detail with reference to FIG. 5.

The memory controller 210 may directly access the memories 240 via the legacy path 234 of the memory accelerator 230 to perform memory operations on the memories 240. The memory operations of the memory controller 210 may include a data processing/restoration operation of the data processing/restoration logic 215. The data processing/restoration logic 215 may have a specific data processing/restoration type and may perform operations of processing data to be programmed to the memories 240 or restoring the data read from the memories 240 based on the data processing/restoration type of the memory controller 210.

The memory accelerator 230 may receive information of the data processing/restoration type of the memory controller 210 from the memory controller 210 and program the same data processing/restoration type as the data processing/restoration logic 215 of the memory controller 210 to the programmable logic 232 based on the information of the data processing/restoration type. In an embodiment, the information of the data processing/restoration type may include information necessary to program the same data processing/restoration logic as the data processing/restoration logic 215. The memory device 220 may include a signal pin for receiving the data processing/restoration type related information from the memory controller 210.

As described above, the programmable logic 232 may perform a data processing/restoration operation corresponding to the data processing/restoration type of the memory controller 210. The memory accelerator 230 may perform a memory operation for distributing the load of the memory controller 210 by using a separate logic path in the memory device 220. The logic path may be different from the legacy path 234 through which the memory controller 210 and the memory accelerator 230 may each individually access the memories 240 directly.

FIG. 3 is a block diagram specifically illustrating the data processing/restoration logic 215 of FIG. 2 according to example embodiments.

Referring to FIG. 3, the data processing/restoration logic 215 may include at least one type of an Error Correcting Code (ECC)/Error Detecting Code (EDC) generator 215_1a and an ECC/EDC checker 215_1b, a scrambler 215_2a and a descrambler 215_2b, a compressor 215_3a and a decompressor 215_3b, and an encryptor 215_4a and a decryptor 215_4b. For example, a first type of the data processing/restoration logic 215 may be the ECC/EDC generator 215_1a and ECC/EDC checker 215_1b, a second type of the data processing/restoration logic 215 may be the scrambler 215_2a and descrambler 215_2b, a third type of the data processing/restoration logic 215 may be the compressor 215_3a and decompressor 215_3b, and a fourth type of the data processing/restoration logic 215 may be the encryptor 215_4a and decryptor 215_4b. The data processing/restoration logic 215 in FIG. 3 performs only error correction, error detection, scrambling, descrambling, compression, decompression, encryption, and decryption operations for convenience of description, but this is merely an example, and the inventive concept is not limited thereto. The data processing/restoration logic 215 may perform various operations. The various functions supportable by the data processing/restoration logic 215 may be compatible by the compatible logic 145 of FIG. 1. The compatible logic 145 may perform a data processing/restoration operation corresponding to a data processing/restoration type of the data processing/restoration logic 215.

Also, in FIG. 3, the ECC/EDC generator 215_1a and the ECC/EDC checker 215_1b are integrated into one logic, but the inventive concept is not limited thereto. An ECC generator and an ECC checker may be implemented to be individually separate from an EDC generator and an EDC checker, respectively.

Specifically, the ECC/EDC generator 215_1a may perform a data processing operation including operations of generating an error correction code or an error detection code based on a predetermined algorithm with respect to predetermined data and adding the generated error correction code or error detection code to the data. The ECC/EDC checker 215_1b may perform a data restoration operation including an error correction or error detection operation on data read from a memory. That is, the ECC/EDC checker 215_1b may perform error correction or error detection based on an error correction code or an error detection code included in the read data, or a predetermined algorithm.

The scrambler 215_2a may perform a data processing operation including a scrambling operation based on a specific pattern with respect to predetermined data. The descrambler 215_2b may perform a data restoration operation including a descrambling operation based on a specific pattern with respect to the data read from the memory.

The compressor 215_3a may perform a data processing operation including a compression operation based on a specific compression method, a specific compression rate, and the like with respect to predetermined data. The decompressor 215_3b may perform a data restoration operation including a decompression operation based on a specific decompression method, a specific compression rate, and the like, on the data read from the memory.

The encryptor 215_4a may perform a data processing operation including an encryption operation based on a specific encryption method, an encryption key, and the like with respect to predetermined data. The decoder 215_4b may perform a data restoration operation including a decryption operation based on a specific decryption method, a decryption key, and the like, on the data read from the memory.

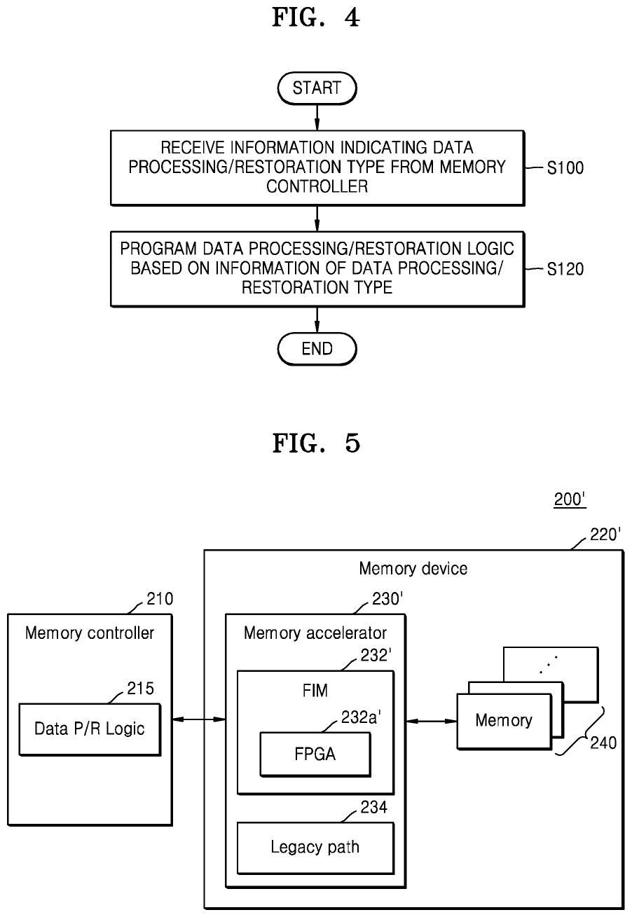

FIG. 4 is a flowchart for explaining operations of the memory accelerator 230 of FIG. 2 for compatibility with the memory controller 210 according to example embodiments.

Referring to FIGS. 2 and 4, the memory accelerator 230 may receive information indicating the data processing/restoration from the memory controller 210 (S100). The information of the data processing/restoration type may include information about the data processing/restoration logic 215 of the memory controller 210. The memory accelerator 230 may program a data processing/restoration logic corresponding to a data processing/restoration type of the memory controller 210 to the programmable logic 232 based on the information of the data processing/restoration type (S120). Thereafter, the programmable logic 232 may perform a data processing/restoration operation in the same data processing/restoration type as the memory controller 210 through which the memory accelerator 230 is compatible with the memory controller 210, and thus, a memory operation that may reduce the load of the memory controller 210 may be performed smoothly.

FIG. 5 is a block diagram illustrating a memory system 200′ according to an embodiment of the inventive concept. Hereinafter, an embodiment in which the programmable logic 232 of FIG. 2 is implemented as a function in memory FIM 232′ including a logic for performing a memory operation is described.

Referring to FIG. 5, the memory system 200′ may include the memory controller 210 and a memory device 220′. The memory device 220′ may include a memory accelerator 230′ and the plurality of memories 240. The memory accelerator 230′ may include the memory (hereinafter referred to as a function in memory FIM) 232′ including a predetermined logic for performing the memory operation and the legacy path 234. The function in memory FIM 232′ may include a programmable logic device (PLD) such as a Field-Programmable Gate Array (FPGA) 232a′. Further, the FPGA 232a′ may be implemented to be embedded in the function in memory FIM 232′. Other configurations of the memory device 220′ except for the memory accelerator 230′ are the same as those of the memory device 220 of FIG. 2, and a detailed description thereof will be omitted.

The function in memory FIM 232′ may include various functions to perform various memory operations for reducing the load of the memory controller 210. In particular, the function in memory FIM 232′ may store commands that are the basis of the various memory operations, and the memory accelerator 230′ may perform the various memory operations by reading the commands from the function in memory FIM 232′ and executing the commands. In particular, the FPGA 232a′ may be a configuration necessary for compatibility between the memory controller 210 and the memory accelerator 230′ in terms of a data processing/restoration operation, and a data processing/restoration logic corresponding to a data processing/restoration type of the memory controller 210 may be programmed to the FPGA 232a′.

In an embodiment, the memory accelerator 230′ may receive information related to a data processing/restoration type including an update image for updating the FPGA 232a′ from the memory controller 210. The memory accelerator 230′ may program the same data processing/restoration logic as the data processing/restoration logic 215 of the memory controller 210 to the FPGA 232a′ based on the updated image.

In another embodiment, the memory accelerator 230′ may receive information related to a data processing/restoration type including addresses of the memories 240 in which the update image for updating the FPGA 232a′ is stored from the memory controller 210. The memory accelerator 230′ may read the update image from the memories 240 based on the information of the data processing/restoration type. The memory accelerator 230′ may program the same data processing/restoration logic as the data processing/restoration logic 215 of the memory controller 210 to the FPGA 232a′ based on the read updated image.

However, the programming method with respect to the FPGA 232a′ described above is merely an example, and the inventive concept is not limited thereto. For example, the same data processing/restoration logic as the data processing/restoration logic 215 of the memory controller 210 may be programmed to the FPGA 232a′ in various ways.

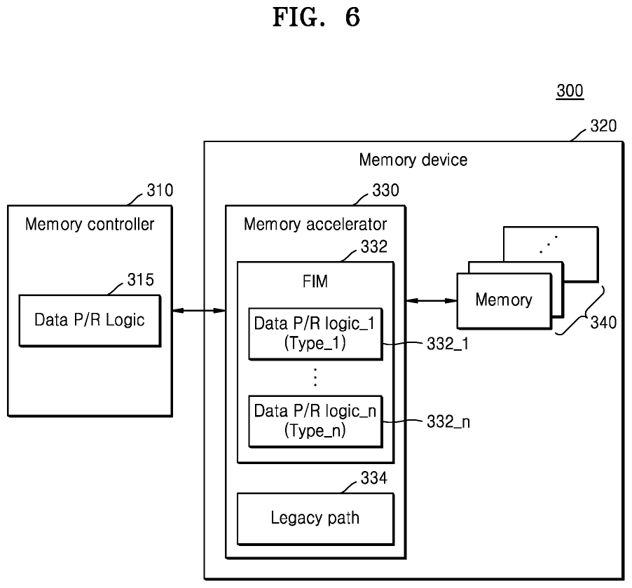

FIG. 6 is a block diagram illustrating a memory system 300 according to an embodiment of the inventive concept. Hereinafter, an embodiment in which the compatible logic 145 of FIG. 1 is implemented as a function in memory FIM 332.

Referring to FIG. 6, the memory system 300 may include a memory controller 310 and a memory device 320. The memory device 320 may include a memory accelerator 330 and a plurality of memories 340. The memory accelerator 330 may include the function in memory FIM 332 and a legacy path 334. The function in memory FIM 332 may include a plurality of data processing/restoration logics 332_1˜332_n corresponding to a plurality of data processing/restoration types Type_1˜Type_n, respectively. Other configurations of the memory device 320 are the same as those of the memory device 220 of FIG. 2, and thus detailed descriptions thereof will be omitted.

Since the function in memory FIM 332 includes the plurality of data processing/restoration logics 332_1˜332_n, the function in memory FIM 332 may select a data processing/restoration logic corresponding to a data processing/restoration type of the memory controller 310 connected to the memory device 320 from the data processing/restoration logics 332_1˜332_n, thereby easily maintaining compatibility with the memory controller 310. Also, since the function in memory FIM 332 includes the various data processing/restoration logics 332_1˜332_n, the function in memory FIM 332 may have a wide spectrum for a compatible memory controller and, regardless of which memory controller is connected, the memory device 320 may maintain compatibility with the memory controller.

In an embodiment, the memory accelerator 330 may provide information about supportable data processing/restoration type to the memory controller 310. For example, the memory accelerator 330 may provide information of data processing/restoration types indicating that the first through nth data processing/restoration types Type_1˜Type_n may be currently supported to the memory controller 310. The memory controller 310 may provide the memory accelerator 330 with a selection signal for selecting a data processing/restoration type thereof from the first through nth data processing/restoration types Type_1˜Type_n that corresponds to the data processing/restoration type of the memory controller 310. The memory accelerator 330 may select a data processing/restoration logic corresponding to the data processing/restoration logic 315 of the memory controller 310 from the plurality of data processing/restoration logics 332_1˜332_n based on the received selection signal.

In another embodiment, the memory accelerator 330 may receive information indicating a data processing/restoration type from the memory controller 310. The information of data processing/restoration type may include information indicating which data processing/restoration type of the data processing/restoration logic 315 of the memory controller 310 has. The memory accelerator 330 may select the data processing/restoration logic corresponding to the data processing/restoration logic 315 of the memory controller 310 from the plurality of data processing/restoration logics 332_1˜332_n based on the information of data processing/restoration type.

The selected data processing/restoration logic may perform a data processing/restoration operation when the memory accelerator 330 performs memory operations on the memories 340, thereby ensuring compatibility with the memory controller 310.

Also, in an embodiment, since the embodiment of the FPGA 232′ of FIG. 5 may be applied to the function in memory FIM 332, when there is no data processing/restoration type corresponding to the data processing/restoration type of the memory controller 310 among data processing/restoration types that may be supported by the memory accelerator 330, the memory accelerator 330 may program the data processing/restoration type corresponding to the data processing/restoration type of the memory controller 310 to the FPGA 232a′ (FIG. 5).

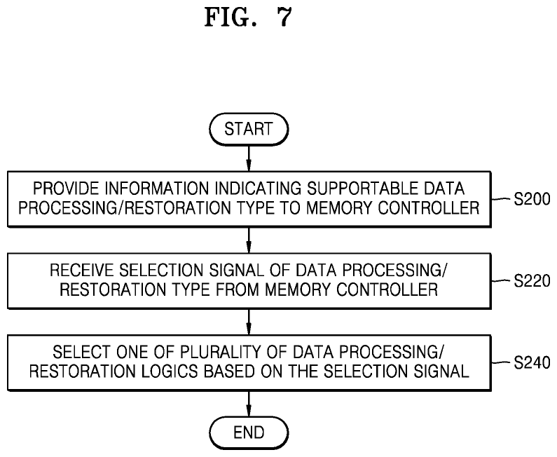

FIG. 7 is a flowchart of operations of the memory accelerator 330 of FIG. 6 for compatibility with the memory controller 310 according to example embodiments.

Referring to FIGS. 6 and 7, the memory accelerator 330 may provide information indicating supportable data processing/restoration types to the memory controller 310 (S200). For example, the memory accelerator 330 may provide information indicating the data processing/restoration types that the first through nth data processing/restoration types Type_1˜Type_n may be currently supported to the memory controller 310. When there is a data processing/restoration type that matches with a data processing/restoration type of the memory controller 310 in the information, the memory controller 310 may provide a selection signal for selecting the data processing/restoration type corresponding to the data processing/restoration type of the memory controller 310 from the first to nth data processing/restoration types Type_1˜Type_n to the memory accelerator 330. The memory accelerator 330 may receive the selection signal of the data processing/restoration type from the memory controller 310 (S220). The memory accelerator 330 may select one of the plurality of data processing/restoration logics 332_1˜332_n based on the selection signal (S240).

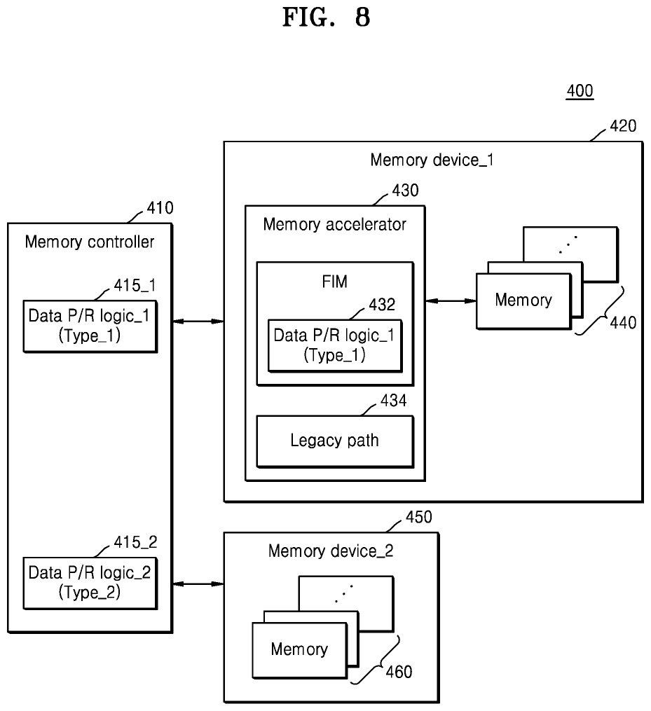

FIG. 8 is a block diagram of a memory system 400 for explaining a structure of a memory controller 410 connected to heterogeneous memory devices 420 and 450 according to an embodiment of the inventive concept.

Referring to FIG. 8, the memory system 400 may include the memory controller 410, a first memory device 420, and a second memory device 450. The first memory device 420 may include a memory accelerator 430 and a plurality of memories 440. The first memory device 420 may include the memory accelerator 430 that maintains compatibility with the memory controller 410 and performs memory operations on the memories 440 as in the embodiments described with reference to FIGS. 1-7. The second memory device 450 may include a plurality of memories 460. The second memory device 450 may not include a memory accelerator, differently from the first memory device 420.

The memory controller 410 may include data processing/restoration logics 415_1 and 414_2 respectively corresponding to the at least two data processing/restoration types Type_1 and Type_2, in contrast to the connection of the first and second memory devices 420 and 450. The memory controller 410 may use the same first data processing/restoration logic 415_1 as a first data processing/restoration logic 432 in the memory accelerator 430 of the first memory device 420 to perform a memory operation on the first memory device 420. For the above operation, the memory controller 410 may receive information indicating supportable data processing/restoration type from the first memory device 420. The memory controller 410 may select the first data processing/restoration logic 415_1 based on the received information.

For a memory operation on the second memory device 450, the memory controller 410 may not need to consider compatibility of a data processing/restoration operation since a memory accelerator is not included in the second memory device 450, and thus, the memory controller 410 may select any one of the data processing/restoration logics 415_1 and 415_2 and perform the memory operation on the second memory device 450 by using the selected one.

In example embodiments, the memory controller 410 may program a new data processing/restoration logic to the memory controller 410 considering a data processing/restoration type that may be supported by a connected memory device.

In example embodiments, the memory controller 410 may program a new data processing/restoration logic to the second memory device 420 considering a data processing/restoration type that may be supported by the memory controller.

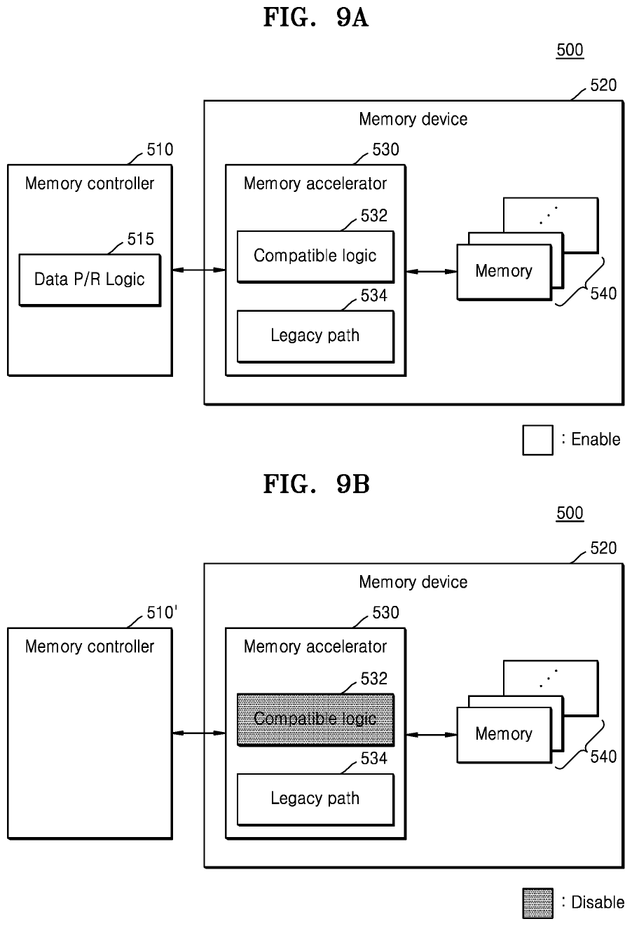

FIGS. 9A and 9B are block diagrams of a memory system 500 for explaining an operation of enabling/disabling a compatible logic 532 according to example embodiments.

Referring to FIG. 9A, the memory system 500 may include a memory controller 510 and a memory device 520. The memory device 520 may include a memory accelerator 530 and a plurality of memories 540. The memory accelerator 530 may control the compatible logic 532 according to whether the memory controller 510 supports a data processing/restoration operation.

The memory controller 510 in FIG. 9A may include a data processing/restoration logic 515, thereby supporting the data processing/restoration operation on data. Accordingly, the memory accelerator 530 may enable the compatible logic 532. The memory accelerator 530 may perform a memory operation for distributing a load of the memory controller 510 and may include a data processing/restoration logic corresponding to a data processing/restoration type of the memory controller 510 in the compatible logic 532 according to the above-described various embodiments, and thus, the memory accelerator 530 may be compatible with the memory controller 510.

Referring to FIG. 9B, the memory device 520 may be connected to a memory controller 510′ that does not support a data processing/restoration operation. Accordingly, the memory accelerator 530 may disable the compatible logic 532. The memory accelerator 530 may perform the memory operation for distributing the load of the memory controller 510 and may not perform the data processing/restoration operation.

In example embodiments, each of the legacy paths 234, 334, 434, and 534 of the memory accelerators 230, 230′, 330, 430, and 530 in FIGS. 2, 5, 6, 8, 9A, and 9B, respectively, may be disposed inside each of the memory accelerators 230, 230′, 330, 430, and 530. In other example embodiments, each of the legacy paths 234, 334, 434, and 534 of the memory accelerators 230, 230′, 330, 430, and 530 in FIGS. 2, 5, 6, 8, 9A, and 9B, respectively, may be disposed outside each of the memory accelerators 230, 230′, 330, 430, and 530.

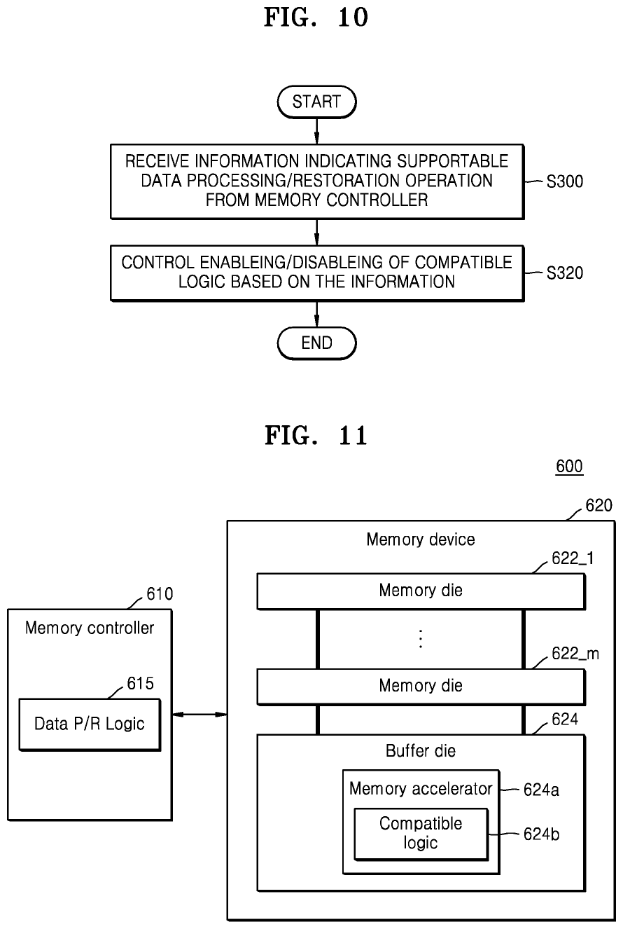

FIG. 10 is a flowchart for explaining operations of the memory accelerator 530 of FIG. 9A for compatibility with the memory controller 510 according to example embodiments.

Referring to FIGS. 9A and 10, the memory accelerator 530 may receive information indicating supportable data processing/restoration operation from the memory controller 510 (S300). The memory accelerator 530 may control enabling/disabling of the compatible logic 532 based on the information (S320).

In example embodiments, each of the memory devices 220, 220′, 320, 420, 450, and 520 as shown in FIGS. 2, 5, 6, 8, 9A, and 9B, respectively, may be implemented as a memory package or a memory module. For example, each of the memory accelerators 230, 230′, 330,430, and 530 may be implemented as a die or a chip which is manufactured from a semiconductor wafer, and each memory of the memories 240,340,440,460, and 540 may be implemented as a die or a chip which is manufactured from a semiconductor wafer.

FIG. 11 is a block diagram illustrating an embodiment of a memory system 600 according to example embodiments.

Referring to FIG. 11, the memory system 600 may include a memory controller 610 and a memory device 620. The memory device 620 may be implemented as a memory package or a memory module. The memory device 620 may include a plurality of memory dies 622_1˜622_m and a buffer die 624. Each of the memory dies 622_1˜622_m may include at least one memory core. The memory core may include a memory cell array, a row decoder, a column decoder, a sense amplifier, and the like, for storing data. The buffer die 624 may perform an interfacing operation for providing data signals, command signals, address signals, and chip selection signals received from the memory controller 610 to the memory dies 622_1˜622_m or providing the data signals received from the memory dies 622_1˜622_m to the memory controller 610.

The memory device 620 may be a single package in which the plurality of memory dies 622_1˜622_m and the buffer die 624 are stacked and packaged. Meanwhile, the plurality of memory dies 622_1˜622_m stacked on the buffer die 624 may be electrically connected to the buffer die 624. To this end, the memory device 620 may include conductive means connecting the memory dies 622_1˜622_m. In an embodiment, the memory device 620 may be a Through Silicon Via (TSV) as the conductive means. To use the TSV as the conduction means between the memory dies 622_1˜622_m, one or more dies in the memory device 620 may include at least one via vertically penetrated therethrough and formed therein.

The buffer die 624 according to an embodiment of the inventive concept may include a memory accelerator 624a for distributing a load of the memory controller 610. The memory accelerator 624a may include a compatible logic 624b for compatibility with the memory controller 610. The compatible logic 624b to which the embodiments described in FIG. 1, etc. are applied may include the same data processing/restoration logic as the data processing/restoration logic 615 of the memory controller 610.

FIG. 12 is a block diagram illustrating a memory device 1000 of a stacked structure according to an embodiment of the inventive concept.

In FIG. 12, the memory device 1000 in the form of a High Bandwidth Memory (HBM) having an increased bandwidth by including a plurality of channels having mutually independent interfaces is shown.

Referring to FIG. 12, the memory device 1000 may include a plurality of dies. In an embodiment, the memory device 1000 may include a buffer die 1050 and one or more memory dies 1010 through 1040 stacked thereon. In an example of FIG. 12, the first through fourth memory dies 1010 through 1040 are provided, but the number of memory dies may be variously changed.

Each of the memory dies 1010 through 1040 may include one or more channels. In FIG. 12, since each die of the one memory device 1000 includes two channels, the memory device 1000 includes eight channels CH1˜CH8. For example, the first memory die 1010 may include the first and third channels CH1 and CH3, the second memory die 1020 may include the second and fourth channels CH2 and CH4, the third memory die 1030 may include the fifth and seventh channels CH5 and CH7, and the fourth memory die 1040 may include the sixth and eighth channels CH6 and CH8.

Also, the memory device 1000 may include a plurality of TSVs 1060 that pass through the memory dies 1010 through 1040. The TSVs 1060 may be arranged corresponding to the plurality of channels CH1 to CH8. When each channel has a bandwidth of 128 bits, the TSVs 1060 may include configurations for data input and output of 1024 bits.

The buffer die 1050 may communicate with a memory controller, receive commands, addresses, and data from the memory controller, and provide the received commands, addresses, and data to the memory dies 1010 through 1040. The buffer die 1050 may include a physical area PHY 1051 connected to the memory controller, a memory accelerator 1052, a TSV region TSV 1053, and a direct access region DA 1055 connected to an external test device. The memory accelerator 1052 according to an embodiment of the inventive concept may include a compatible logic (not shown). The compatible logic (not shown) to which the embodiments described with reference to FIG. 1, etc. are applied may include the same data processing/restoration logic as a data processing/restoration logic of the memory controller.

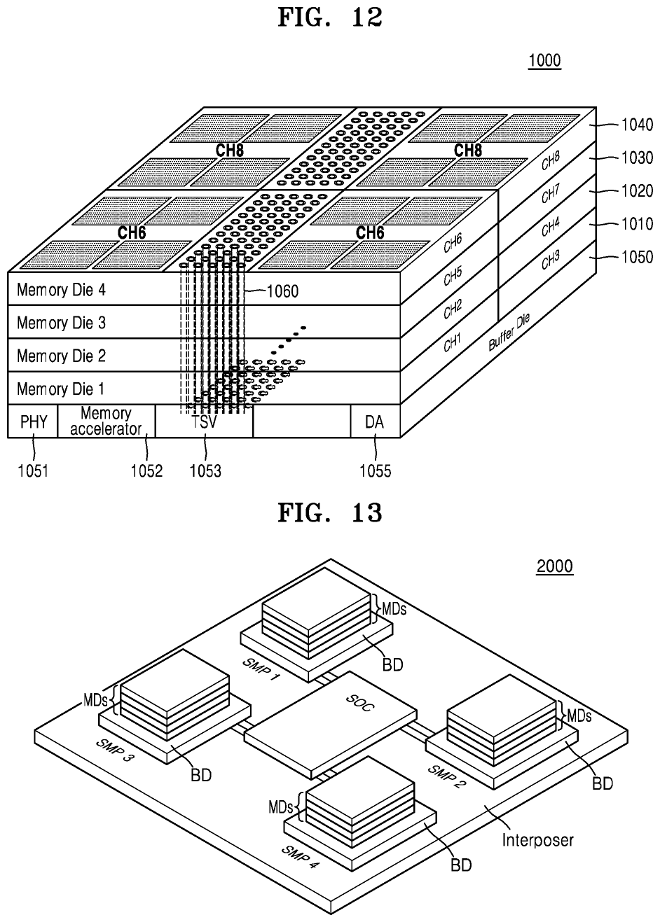

FIG. 13 is a diagram illustrating a semiconductor memory module 2000 including a plurality of semiconductor memory packages SMP1 to SMP4 according to an embodiment of the inventive concept.

Referring to FIG. 13, the semiconductor memory module 2000 may include the plurality of semiconductor memory packages SMP1 TO SMP4 and an interposer. Each of the semiconductor memory packages SMP1 TO SMP4 may include a buffer die BD and a plurality of memory dies MDs stacked on one side of the buffer die BD. A plurality of bumps may be formed on each of the semiconductor memory packages SMP1 to SMP4 and disposed on one side of the interposer such that the bumps are electrically connected to predetermined conductive elements included in the interposer. Also, a system-on-chip SoC for controlling operations of the semiconductor memory packages SMP1 to SMP4 may be disposed on one side of the interposer. The system-on-chip SoC and the semiconductor memory packages SMP1 to SMP4 may be electrically connected through the conductive elements included in the interposer, respectively.

According to an embodiment, the buffer die BD of at least one of the semiconductor memory packages SMP1 to SMP4 may include a memory accelerator including a compatible logic to which the embodiments described with reference to FIG. 1, etc. are applied. Furthermore, the system-on-chip SoC may include a plurality of data processing/restoration logics corresponding to various types to provide compatibility regardless of whether the semiconductor memory packages SMP1 to SMP4 include memory accelerators as in the embodiment described with reference to FIG. 8.

In example embodiments, each memory of the memories 240, 340, 440, 460, 540, 622_1˜622_m, 1010˜1040, and MDs as shown in FIGS. 2, 5, 6, 8, 9A, 9B, 11, 12, and 13, respectively, may be implemented as a volatile memory or an non-volatile memory such as a dynamic random access memory (DRAM), a synchronous dynamic random access memory (SDRAM), a double data rate synchronous DRAM (DDR SDRAM), a low power double data rate (LPDDR) SDRAM, a Rambus DRAM (RDRAM), a Dual In-line Memory Module (DIMM), a mobile DRAM, a static random access memory (SRAM), an NAND flash memory, a NOR flash memory, an electrically erasable programmable read-only memory (EEPROM), a phase change random access memory (PRAM), a resistance random access memory (RRAM), a Nano Floating Gate Memory (NFGM), a Polymer Random Access Memory (PoRAM), a Magnetic Random Access Memory (MRAM), a Ferroelectric Random Access Memory (FRAM), etc.

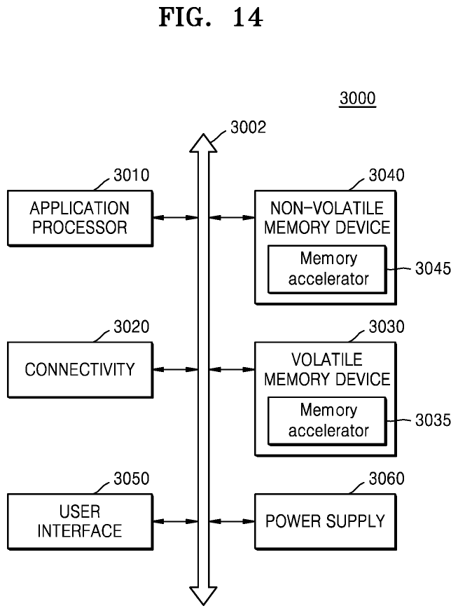

FIG. 14 is a block diagram showing an example in which a memory device is applied to a mobile system 3000 according to an embodiment of the inventive concept.

Referring to FIG. 14, the mobile system 3000 may include an application processor 3010, a connectivity 3020, a first memory device 3030, a second memory device 3040, a user interface 3050, and a power supply 3060. The first memory device 3030 may include a volatile memory device. The second memory device 3040 may include a non-volatile memory device. According to an embodiment, the mobile system 3000 may be a mobile phone, a smart phone, a personal digital assistant (PDA), a portable multimedia player (PMP), a digital camera, a music player, a portable game console, a navigation system, or the like.

The application processor 3010 may execute applications providing Internet browsers, games, animations, and the like. According to an embodiment, the application processor 3010 may include a single core or multiple cores. For example, the application processor 3010 may include a dual-core processor, a quad-core processor, and a hexa-core processor. Also, according to an embodiment, the application processor 3010 may further include a cache memory located inside or outside.

The connectivity 3020 may perform wireless communication or wired communication with an external device. For example, the connectivity 3020 may perform Ethernet communication, Near Field Communication (NFC), Radio Frequency Identification (RFID) communication, Mobile Telecommunication, memory card communication, universal serial bus (USB) communication, and the like. For example, the connectivity 3020 may include a baseband chipset and may support communication such as GSM, GRPS, WCDMA, and HSxPA.

The first memory device 3030, which is a volatile memory device, may store data processed by the application processor 3010, or may operate as a working memory. The first memory device 3030 may correspond to at least one of the memory devices described with reference to FIGS. 2, 5, 6, 8, 9A, 9B and the like. The first memory device 3030 may include a memory accelerator 3035 including a compatible logic to which the embodiments of the inventive concept are applied. The first memory device 3030 may reduce a load of the application processor 4010 through the memory accelerator 3035 and maintain compatibility with the application processor 3010 with respect to a data processing/restoration operation.

The second memory device 3040, which is a non-volatile memory device, may store a boot image for booting the mobile system 3000. The second memory device 3040 may correspond to at least one of the memory devices described with reference to FIGS. 2, 5, 6, 8, 9A, 9B and the like. For example, the non-volatile memory device 3040 may be implemented as electrically erasable programmable read-only memory (EEPROM), NAND flash memory, NOR flash memory, phase change random access memory (PRAM), resistance random access memory (RRAM), a Nano Floating Gate Memory (NFGM), Polymer Random Access Memory (PoRAM), Magnetic Random Access Memory (MRAM), Ferroelectric Random Access Memory (FRAM), or a memory similar thereto. The second memory device 3040 may include a memory accelerator 3045 including a compatible logic to which the embodiments of the inventive concept are applied. The second memory device 3040 may reduce the load of the application processor 3010 through the memory accelerator 3045 and maintain compatibility with the application processor 3010 with respect to the data processing/restoration operation.

The user interface 3050 may include one or more input devices, such as a keypad, a touch screen, and/or a speaker, a display device, and one or more output devices. The operating voltage of the power supply 3060 may be supplied. Also, according to an embodiment, the mobile system 3000 may include a camera image processor (CIP), and may further include a storage device such as a memory card, a solid state drive (SSD), a hard disk drive (HDD), a CD-ROM, and the like.

While the inventive concept has been particularly shown and described with reference to embodiments thereof, it will be understood that various changes in form and details may be made therein without departing from the spirit and scope of the following claims.

1. A memory device comprising:
at least one memory configured to communicate with a memory controller; and
a memory accelerator provided separate from the at least one memory and configured to communicate with the at least one memory,
wherein the memory accelerator comprises a compatible logic configured to perform a data processing/restoration operation adaptively corresponding to a data processing/restoration type of the memory controller.

2. The memory device of claim 1, wherein the data processing/restoration operation comprises at least one of an error correcting code (ECC) generation/check operation, an error detecting code (EDC) generation/check operation, a scramble/descramble operation, a compression/decompression operation, and an encryption/decryption operation.

3. The memory device of claim 1, wherein the compatible logic comprises a data processing/restoration logic programmed to perform the data processing/restoration operation corresponding to the data processing/restoration type of the memory controller.

4. The memory device of claim 3, wherein the compatible logic further comprises a field-programmable gate array (FPGA), and
wherein the data processing/restoration operation corresponding to the data processing/restoration type of the memory controller is dynamically programmed to the FPGA.

5. The memory device of claim 1, wherein the compatible logic comprises a plurality of data processing/restoration logics corresponding to a plurality of data processing/restoration types, respectively, of the memory controller.

6. The memory device of claim 5, wherein the data processing/restoration operation corresponding to the data processing/restoration type of the memory controller is selected from the plurality of data processing/restoration logics to perform the data processing/restoration operation.

7. The memory device of claim 1, wherein the compatible logic is enabled or disabled according to whether the memory controller supports the data processing/restoration operation.

8. The memory device of claim 1, further comprising:
a signal pin configured to receive information indicating the data processing/restoration type from the memory controller.

9. The memory device of claim 1, wherein the at least one memory is a first memory die, and the memory device further includes:
a buffer die configured to communicate with the memory controller; and
a plurality of second memory dies stacked on the first memory die and the buffer die,
wherein the buffer die comprises the memory accelerator.

10. The memory device of claim 1, further comprising:
a first path through which the memory controller is directly accessible to the at least one memory; and
a second path through which the memory accelerator is directly accessible to the at least one memory.

11. The memory device of claim 1, wherein the memory accelerator is implemented as an off-chip separate from the at least one memory.

12. A memory system comprising:
a plurality of memories;
a memory controller configured to perform a first memory operation on the plurality of memories; and
a memory accelerator provided separate from the plurality of memories and configured to perform a second memory operation on the plurality of memories to access the plurality of memories,
wherein, when the memory accelerator performs the second memory operation, the memory accelerator configures a compatible logic set to have a data processing/restoration type corresponding to a data processing/restoration type that is a basis for the first memory operation of the memory controller.

13. The memory system of claim 12, wherein the memory accelerator is configured to receive information related to the data processing/restoration type that is the basis for the first memory operation of the memory controller and set the compatible logic based on the information related to the data processing/restoration type.

14. The memory system of claim 13, wherein the compatible logic further comprises a field-programmable gate array (FPGA), and
wherein the memory accelerator is configured to dynamically program a data processing/restoration logic corresponding to the data processing/restoration type that is the basis for the first memory operation to the FPGA, based on the information related to the data processing/restoration type.

15. (canceled)

16. (canceled)

17. The memory system of claim 13, wherein the compatible logic comprises a plurality of data processing/restoration logics each corresponding to respective plurality of data processing/restoration types, and
wherein the memory accelerator is configured to select any one of the plurality of data processing/restoration logics based on the information related to the data processing/restoration type.

18. The memory system of claim 13, wherein the memory accelerator is configured to determine whether the memory controller supports a data processing/restoration operation based on the information related to the data processing/restoration type and control enabling or disabling of the compatible logic based on a result of the determining.

19. The memory system of claim 12, wherein the memory system includes a memory module and a system on chip,
wherein the plurality of memories and the memory accelerator are included in the memory module, and
wherein the memory controller is included in the system on chip.

20. A memory system comprising:
a plurality of memories;
a memory controller configured to access the plurality of memories; and
a memory accelerator provided separate from the plurality of memories and configured to access the plurality of memories,
wherein the memory accelerator comprises a compatible logic configured to either perform a data processing/restoration operation adaptively corresponding to a data processing/restoration type of the memory controller or do not perform the data processing/restoration operation based on whether the memory controller supports the data processing/restoration type.

21. The memory system of claim 20, wherein the memory accelerator is configured to enable the compatible logic when the memory controller supports the data processing/restoration type or disable the compatible logic when the memory controller does not support the data processing/restoration type.

22. The memory system of claim 20, wherein the data processing/restoration operation comprises at least one of an error correcting code (ECC) generation/check operation, an error detecting code (EDC) generation/check operation, a scramble/descramble operation, a compression/decompression operation, and an encryption/decryption operation.
